(19) United States
(12) Patent Application Publication
(10) Pub. No.: US 2004/0133517 A1
(43) Pub. Date: Jul. 8, 2004

(54) Computer-implemented system and method for processing check images

(76) Inventor: Miguel A. Zubizarreta, Westlake, OH (US)

Correspondence Address: Paul E. Franz, Jones Day, North Point, 901 Lakeside Avenue, Cleveland, OH, 44114, US

(21) Appl. No.: 10/705,334

(22) Filed: Nov. 10, 2003

Related U.S. Application Data
(60) Provisional application No. 60/424,885, filed on Nov. 8, 2002.

(51) Int. Cl. G06F 17/60

(52) U.S. Cl. 705/44

(57) ABSTRACT

A computer-implemented check processing system that associates sorted check image files and associated check image data with an endpoint for direct distribution to the endpoint.

This application claims the benefit of priority to U.S. Provisional Application Ser. No. 60/424,885, filed on Nov. 8, 2002, the entire disclosure of which is incorporated herein by reference.

### TECHNICAL FIELD

This patent document relates generally to sorting of the images of checks and more particularly to a computer-implemented check image sorter system and computer-implemented automated clearing and distribution system.

### BACKGROUND AND SUMMARY

Typically, all of the checks deposited by customers into banks are physically sorted and returned to the Federal Reserve Bank, and then again physically sorted and returned to the banks where the accounts reside. These activities consume a great deal of resources, even for banks that use physical check sorters (e.g., physical machines that sort paper checks and may be equipped with imaging cameras to capture images of the checks that they process). This is the case, at least in part, because until recently all banks have provided physical checks to the Federal Reserve Bank for sorting and further processing.

To address such concerns as well as others, computer-implemented systems and methods are provided in accordance with the teachings disclosed herein. As an example, a system and method are used to reduce the effort and cost of electronic presentment by allowing a computer-based check image sorter to capture a financial institution's checks without physically separating them. The computer-based check image sorter separates each of the checks based on the endpoint. An endpoint is a location to which checks need to be presented for payment. There can be one or more ABA numbers or ABA account number combinations for a specific endpoint. A bank then captures digital images of check images deposited and sorts the check images into sorted check image files that are transmitted in order to present the items for payment.

### BRIEF DESCRIPTION OF THE DRAWINGS

FIG. 1 is a block diagram depicting processing of checks for electronic sorting and distribution.

FIG. 2 is a block diagram depicting software and computer components utilized in a computer-implemented system for the sorting of electronic check images.

FIG. 3 is a structure diagram depicting a database table used to maintain the sorting information.

FIG. 4 is a block diagram depicting a computer-implemented automated clearing manager process for distributing the sorted check files to corresponding endpoints.

FIG. 5 is a block diagram depicting a computer-implemented automated clearing manager process for receiving check files from other locations and accounting for and reporting data in the received check files.

FIGS. 6-10 are block diagrams depicting additional systems and methods for check processing and arrangements facilitated thereby.

### DETAILED DESCRIPTION

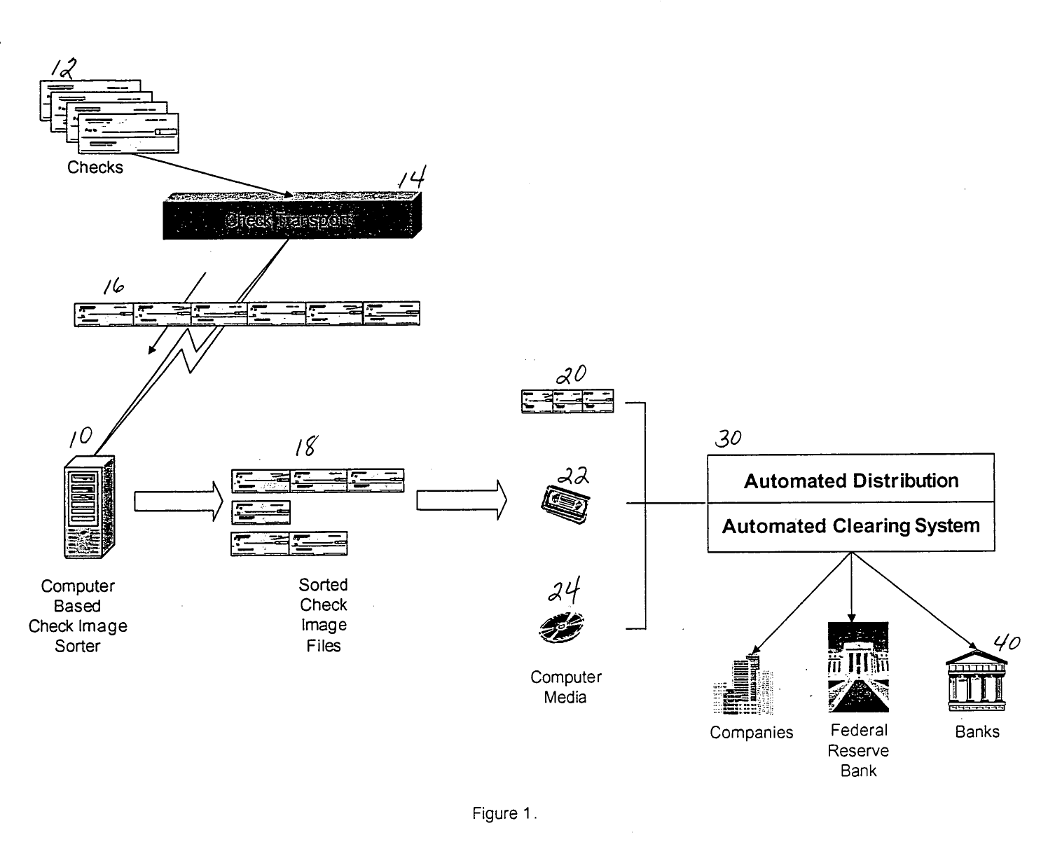

FIG. 1 is a block diagram depicting the processing of checks for electronic sorting and distribution. A computer-based check image sorter 10 facilitates the electronic processing, distribution and presentment. FIG. 1 depicts collection of checks 12 received by a check processing machine 14. The check processing machine 14 may be, for example, a check sorter, a check reader and sorter, or a check transport. Other check processing machines 14 may also be used.

This check processing machine 14 captures images of the checks 12 along with the data contained in the Magnetic Ink Character Recognition line, commonly referred to as the MICR line. The MICR data line contains the number of the bank, commonly referred to as the ABA number, and the check account number, check serial number and dollar amount of the check. The resulting image and data files 16 are transferred to a computer system which comprises the computer-based check image sorter 10. The example computer system may comprise a single computer, or a plurality of computers in communication over a network, such as a Local Area Network (LAN), a Wide Area Network (WAN), or even the Internet.

The computer-based check image sorter 10 creates sorted check image and data files 18 that can be stored on a number of different types of electronic computer media, such as a hard drive 20, magnetic tape 22, or CD-ROM 24. The sorted check files 18 created may conform with standards as defined by an electronic payment association, such as NACHA, or by other regulatory standards.

The sorted check files 18 may then be accessed by an automated distribution or clearing system 30 for transmission to one or more institutions 40 that either honor the checks or provide further check processing. The institutions 40 may comprise a banking institution, such as a bank, savings and loan, or credit union; a private or public company; or other type of institution.

The automated distribution or clearing system 30 may be in direct communication with the computer-based check image sorter 10, e.g., the automated distribution or clearing system 30 may be running on the same computer system as the computer-based check image sorter 10, or may even be part of a software program that comprises both the computer-based check image sorter 10 and the automated distribution system 30. Alternatively, automated distribution or clearing system 30 may comprise a separate computer system in communication with the computer-based check image sorter 10 over a network, such as a Local Area Network (LAN), a Wide Area Network (WAN), or even the Internet. In this alternative embodiment, the sorted check image files 18 may be electronically transmitted to the automated distribution system, or the electronic computer media may be physically delivered to the automated distribution or clearing system 30. The electronic transmission may be a timed batch transmission of a sorted check file via secured communications channels to a specific electronic address, such as a TCP/IP location or a URL.

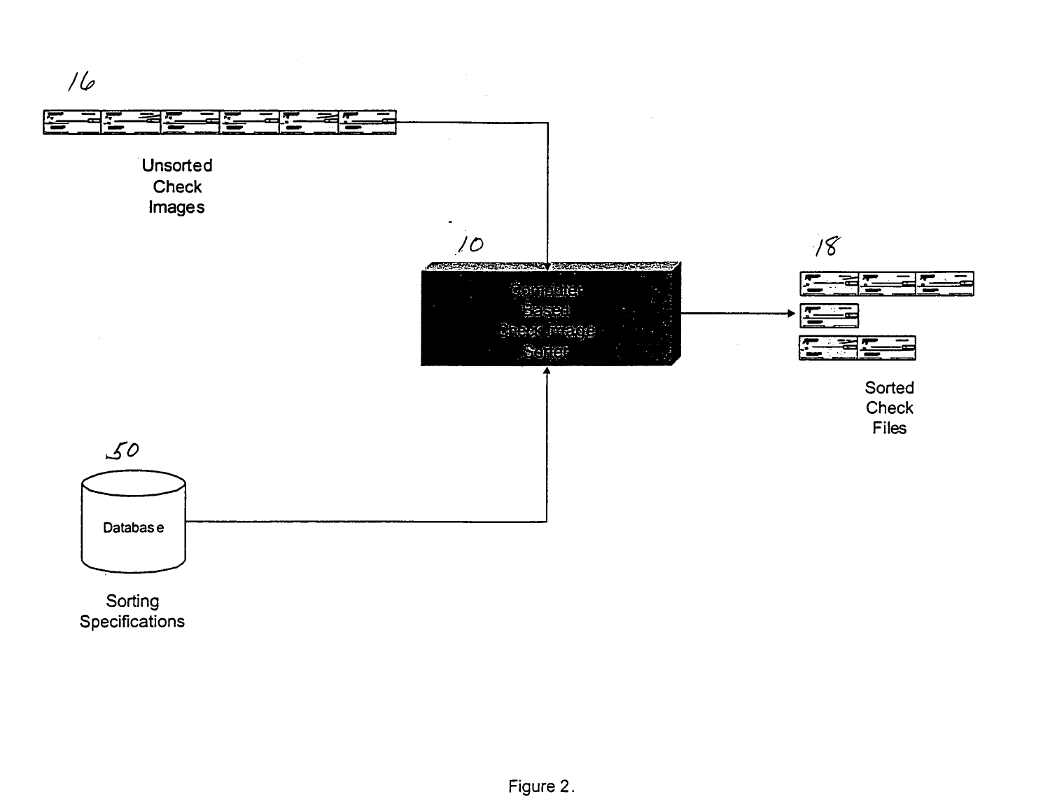

FIG. 2 is a block diagram depicting software and computer components utilized in a computer-implemented system for the sorting of electronic check images. FIG. 2 depicts in greater detail the processing of the input check file 16 on the computer-based check image sorter 10. The computer-based check image sorter 10 reads the associated check data in the input check file 16 and the sorting specifications stored in a sorting database 50 and processes the checks from the check file 16 and generates the sorted check files 18.

The sorting specifications of the sorting database 50 are used to define endpoints where one or more ABA numbers will be sorted into a single file. The sorting database 50 may also define which ABA number will be used to name the sorted check files 18, if the sorted check files 18 are named by ABA numbers.

While the sorting specifications are illustrated as being stored in a sorting database 50, other storage structures may be used. For example, the sorting specifications may be stored in an indexed flat file, or even a text file. Typically, however, a database structure is used to store the sorting specification so that processing time is reduced.

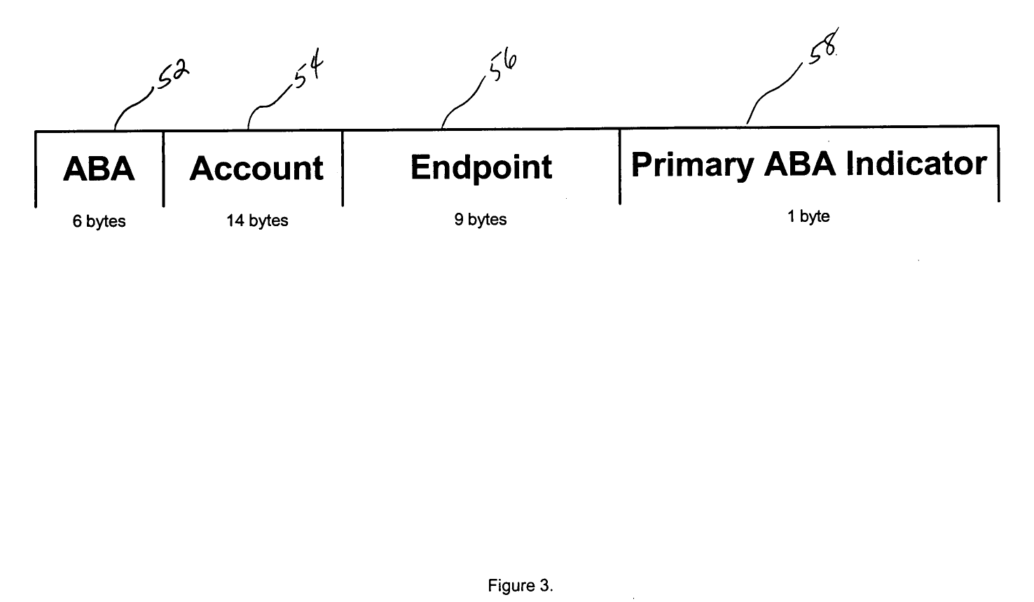

FIG. 3 is a structure diagram depicting a database structure used to maintain the sorting information in the database 50. This database structure includes an ABA number field 52, and account number field 54, an endpoint number field 56, and a primary ABA indicator field 58. A primary ABA indicator field 58 is populated with data if the record stores a primary ABA number for the endpoint specified in the endpoint field 56. For example, if a processing center is to receive checks with multiple ABA numbers, and the processing center itself has an associated ABA number, then the primary ABA indicator 58 would be populated with the processing center's ABA number.

In an alternative embodiment, the primary ABA indicator field 58 may be replaced by a unique identifier field. Thus, an endpoint may be specified by a unique identifier and receive all associated check images associated with the unique identifier.

A standard naming convention may be used for the sorted check image files 18 created by the computer-based check image sorter 10. An illustrative naming convention may be as follows:

DestinationID-SourceID-Date-RunID.scf

The DestinationID is an identifier associated with an endpoint. The DestinationID may be an endpoint's ABA number, or may be another unique identifier. The SourceID is an identifier associated with a processing center that created the sorted check image files 18. The SourceID may be the processing center's ABA number, or may be another unique identifier. Alternatively, the SourceID may be the location at which the check image was captured. The date is the date on which the check image file was created, such as YYYYMMDD. The RunID is a run identifier number or string. The .scf extension is a file association for “sorted check file.”

For the banking industry specifically, an illustrative naming convention may be as follows:

DestinationABA-CaptureLocationABA-Date-RunID.SCF

The DestinationABA is the ABA number associated with an endpoint. The CaptureLocationID is an ABA number associated with the bank that captured the check image. Alternatively, the CaptureLocationID may be the ABA number of the check processing center that created the sorted check image file. The date is the date on which the check image file was created, such as YYYYMMDD. The RunID is a run identifier number or string.

A first naming convention may have the destination bank's ABA number as the first section of the name, followed by the image capture bank's ABA number as the second field and then the date of the capture along with a run number. In this example, the date and run number combination are unique for a given capture location.

In an alternative naming convention, the naming convention may have the destination bank's ABA number as the first section of the name, followed by the processing center's ABA number as the second field, and then the date of the creation of the check image file with a run number. In this naming convention, the sorted check image file 18 may include checks from a plurality of capture locations.

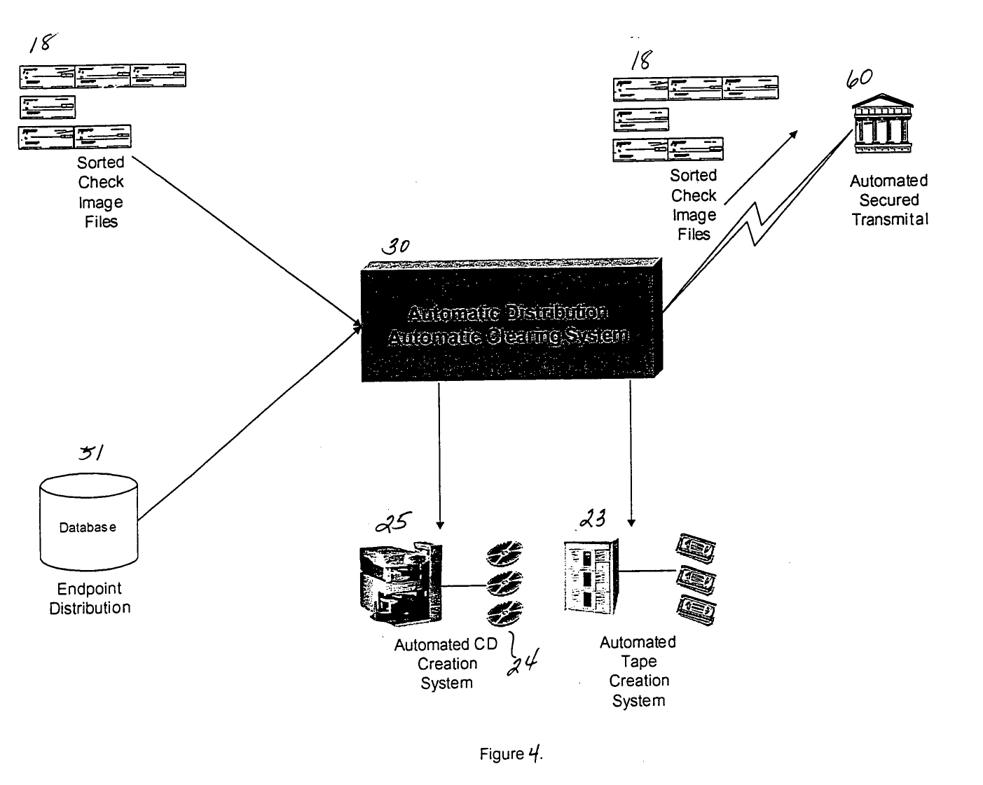

FIG. 4 is a block diagram depicting a computer-implemented automated clearing manager process for distributing the sorted check files to corresponding endpoints. A sorted check file 18 is distributed by the automated distribution or clearing system 30 according to the data stored in an endpoint distribution database 51. The endpoint distribution database 51 may specify an automated clearing manager that distributes the sorted check files to their corresponding endpoints. For example, the sorted check image files 18 shown in FIG. 4 may each have the same endpoint, and thus are transmitted to the institution 60 associated with that endpoint. The transmission may be a secured transmission using known security methods, such as public/private key encryption.

In one embodiment, the endpoint distribution database 51 and the sorting database 50 may be realized by a single database or database file. In another embodiment, separate databases may be used to realize the endpoint distribution database 51 and the sorting database 50.

The endpoint distribution database 51 may also store data that causes the automated distribution or clearing system 30 to direct the sorted files 18 to servers 23 and 25 which are respectively capable of automatically creating computer tapes 22 and CDs 22. Disposition of the stored check image files 18 may then be determined according to a service agreement between the automated distribution or clearing system 30 and the institution 60. For example, the sorted check image files 18 may then be stored for a long term at the automated distribution or clearing system 30 in case the institution requests a retransmission of the files 18, or may alternatively be provided to the institution 60. A document management system may be used to facilitate access and retrieval of the sorted check image files 18.

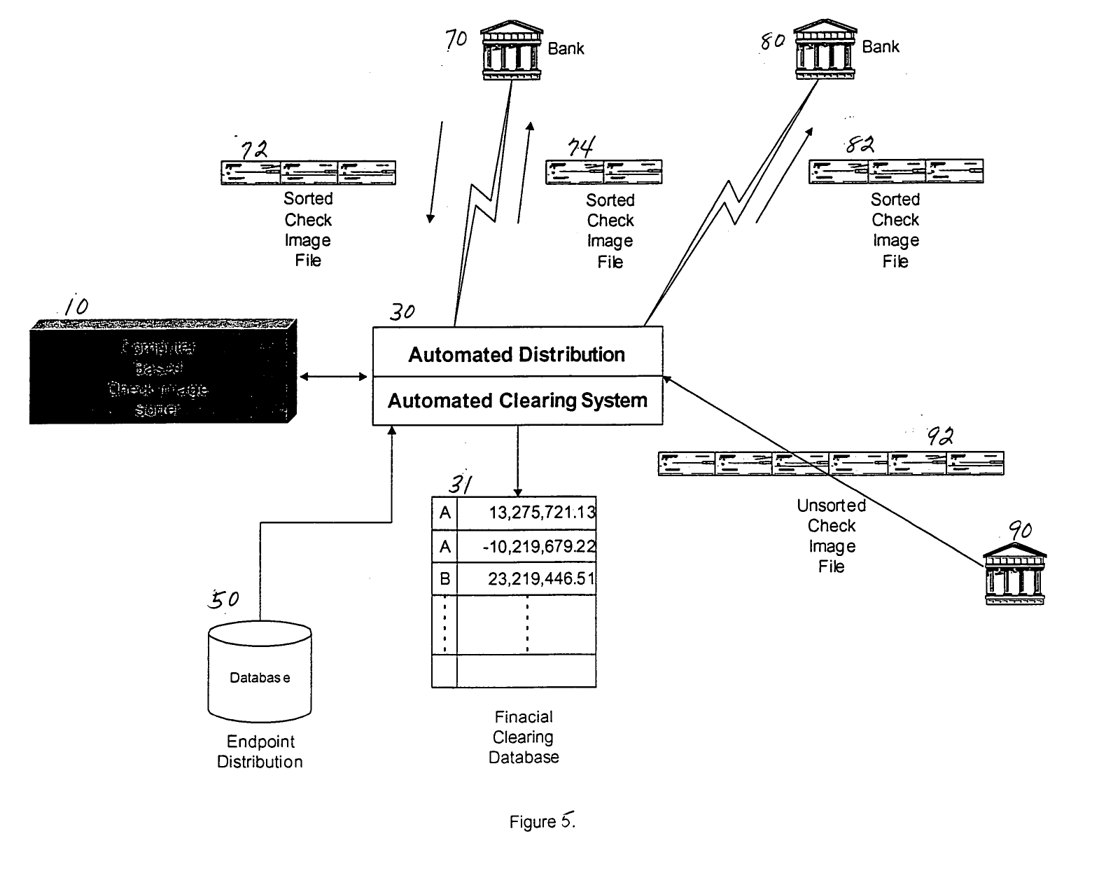

FIG. 5 is a block diagram depicting the computer-implemented automated distribution or clearing system 30 receiving check files 72 and 92 from other locations and accounting for and reporting data in the received check files. FIG. 5 depicts the automated distribution or clearing system 30 using the information in the endpoint distribution database 51 to transmit sorted check files 74 and 82 to institutions 70 and 80, respectively, and recording the transactions in a financial clearing database 31.

A service center may comprise the computer-based check image sorter 10 and the automated distribution or clearing system 30. Bank 70 may provide sorted check image files 70 to the automated distribution or clearing system 30, and may receive sorted check image files 74 from the automated distribution or clearing system 30. Bank 80 may receive sorted check image files 82 from the automated distribution or clearing system 30. Bank 90 may provide unsorted check image files 92 to the automated distribution or clearing system 30. A financial clearing database 31 stores data related to the number of checks sent to and received from each of the banks 70, 80, and 90, and also the corresponding amounts of the checks. Reports may be generated that reconcile the clearing of outbound checks versus inbound checks.

The service center may provide automated distribution and clearing according to a service agreement. For example, each bank 70, 80, and 90 could be charged a unit cost per check received, a unit cost per check image sorted, a unit cost per check distributed, and/or a unit cost per check cleared. Combinations of unit costs may also be used. For example, bank 70 possesses a computer-based check image sorter 10 and provides the sorted check image file 72 to the automated distribution or clearing system 30. Bank 90 does not possess a computer-based check image sorter 10 and thus provides only an unsorted check image file 92 to the automated distribution or clearing system 30. Thus, for each check from bank 70 processed, the service center may charge only a unit cost per check received, while for each check from bank 90 processed, the service center may charge a unit cost per check received and a unit cost per check sorted. Other service pricing arrangements may also be used.

Other relationships between banks and third parties may also be facilitated by the computer-implemented systems and methods for processing check images disclosed herein. For example, a banking institution itself may scan and create digital images of the checks and related data files, or may receive digital images and related data files from a third party. Once the digital check files are created, then the check image sorter system may be used to create the sorted check image files. The parties that may perform the scanning and/or sorting may range greatly, such as an independent contractor who specializes in digital content creation. Alternatively, the scanning and sorting may be carried out by a company who is the payee designated on the check. For example, a grocery store may receive many checks from many bank accounts at different banks, and thus may scan the check images and create the sorted check image file. The grocery store may even implement an automated distribution system so that the sorted check image files are distributed directly to their corresponding banks.

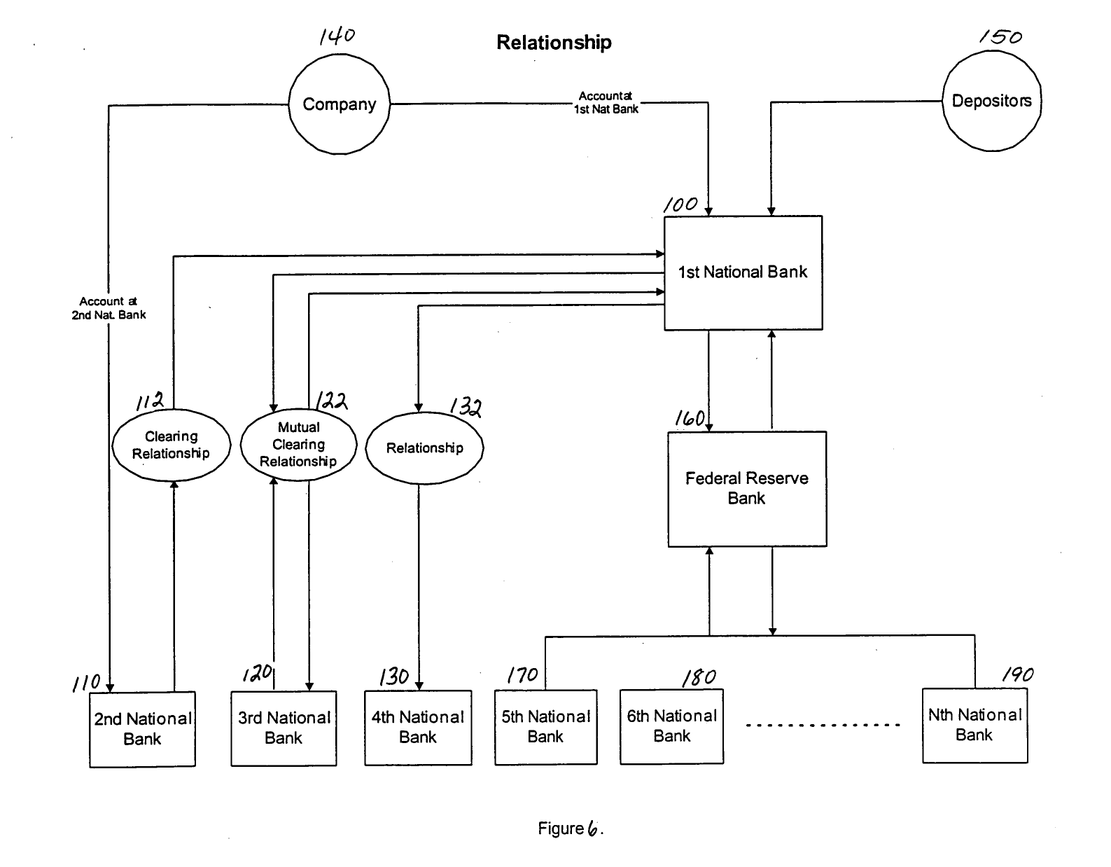

Other types of relations may also be facilitated by the use of the check image sorter approaches described herein. FIGS. 6-10 are block diagrams depicting additional process flows for handling checks. In FIG. 6, 1^{st} National Bank 100, which has a check image sorter 10, forms relationships (e.g., via agreements, contracts or the like) with several other banking institutions 2^{nd} National Bank 110, 3^{rd} National Bank 120, and 4^{th} National Bank 130. Company 140 has accounts at both the 1^{st} National Bank 100 and the 2^{nd} National Bank 110, and the 1^{st} National Bank 100 receives deposits from depositors 150.

The first relationship 112 with the 2^{nd} National Bank 110 is a clearing relationship in which sorted check images are sent to the 1^{st} National Bank 100; the second relationship 122 with the 3^{rd} National Bank 120 is a mutual clearing relationship in which sorted check images are sent between the 1^{st} National Bank 100 and the 3^{rd} National Bank 120; and the third relationship 132 with the 4^{th} National Bank 130 may be some other relationship facilitated by the use of the check image sorter systems and methods described herein, such as a reciprocal service relationship or a service provider relationship. Banks 170, 180 and 190 do not have an established processing service, and thus receive their corresponding checks from the Federal Reserve Bank. Thus, checks cleared against banks 170, 180 and 190 incur a processing fee by the Federal Reserve Bank, while those checks cleared by bank 120 that are provided by bank 100 do not incur a processing fee by the Federal Reserve Bank 160. Because the relationship 122 is reciprocal, checks cleared between banks 100 and 120 do not incur a processing fee by the Federal Reserve Bank 160.

The company 140 may be a large company, such as a utility, having a correspondingly large number of customers with accounts at the 2^{nd} National Bank 110. Thus, the company 140 may directly distribute the sorted check images to the 2^{nd} National Bank 110, and the remainder of its check images to the 1^{st} National Bank 100. Those checks provided directly from the company 140 to the 2^{nd} National Bank 110 are settled more quickly than if they were provided to the 1^{st} National Bank 100, and also do not incur a check cashing fee that the 1^{st} National Bank 100 may charge. For those checks that are sent from the company 140 to the 1^{st} National Bank 100, the 1^{st} National Bank 100 may clear them directly in accordance with the systems and methods as described above, or may pass them on to the Federal Reserve Bank 160. The company 140 would thus incur the corresponding processing fees.

The 1^{st} National Bank 100 may offer to the company 140 as an optional service the check clearing and distribution service facilitated by the systems and method disclosed herein. For example, the 1^{st} National Bank 100 may offer the service at a lower per unit cost than would be normally incurred if the checks are passed directly to the Federal Reserve Bank 160. The 1^{st} National Bank 100 may also distribute check files having a particular banking institution as their designated endpoint directly to the particular banking institution. Direct distribution to the endpoint institution reduces expenses at least in part by not having the Federal Reserve Bank 160 directly or indirectly involved. The 1^{st} National Bank 100 may optionally charge a small fee due to this arrangement. In addition to direct distribution, check image files may also be distributed to the Federal Reserve Bank.

The 1^{st} National Bank 100 also may provide sorted check images to the Federal Reserve Bank 160, which in turn may provide the corresponding sorted check images to multiple other banks (e.g., 5^{th} National Bank 170, 6^{th} National Bank 180 . . . N^{th} National Bank 190) as shown and as previously described.

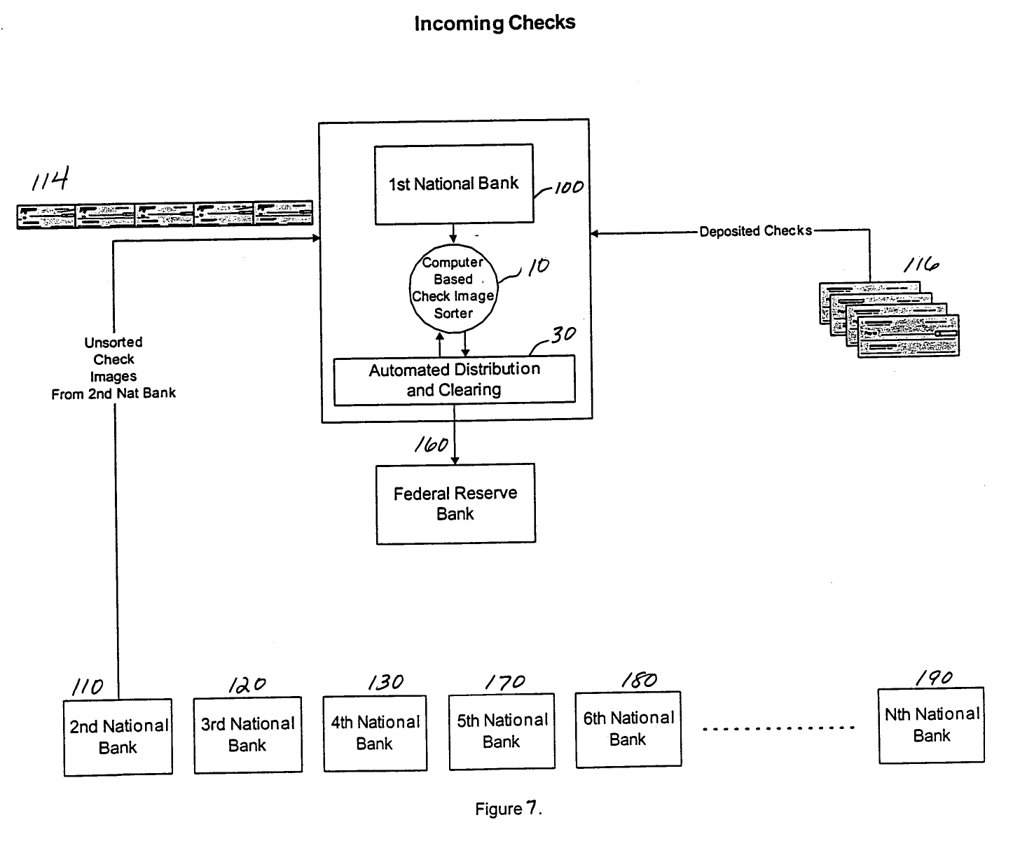

FIG. 7 provides a block diagram illustrating the processing of incoming checks to the 1^{st} National Bank 100. The 2^{nd} National Bank 110 provides unsorted check images 114 to the 1^{st} National Bank 100 pursuant to an agreement between the 2^{nd} National Bank 110 and the 1^{st} National Bank 100. Deposited checks 116 are also provided to the 1^{st} National Bank 100. The check images 114 and the deposited checks 116 are then processed accordingly by the check image sorter system 10 and automated distribution and clearing system 30. For example, the unsorted check images 114 may be sorted, and the deposited checks 116 may be scanned, imaged and sorted. Absent any further agreement requirements, the 1^{st} National Bank 100 then provides the sorted check image files to the Federal Reserve Bank 160.

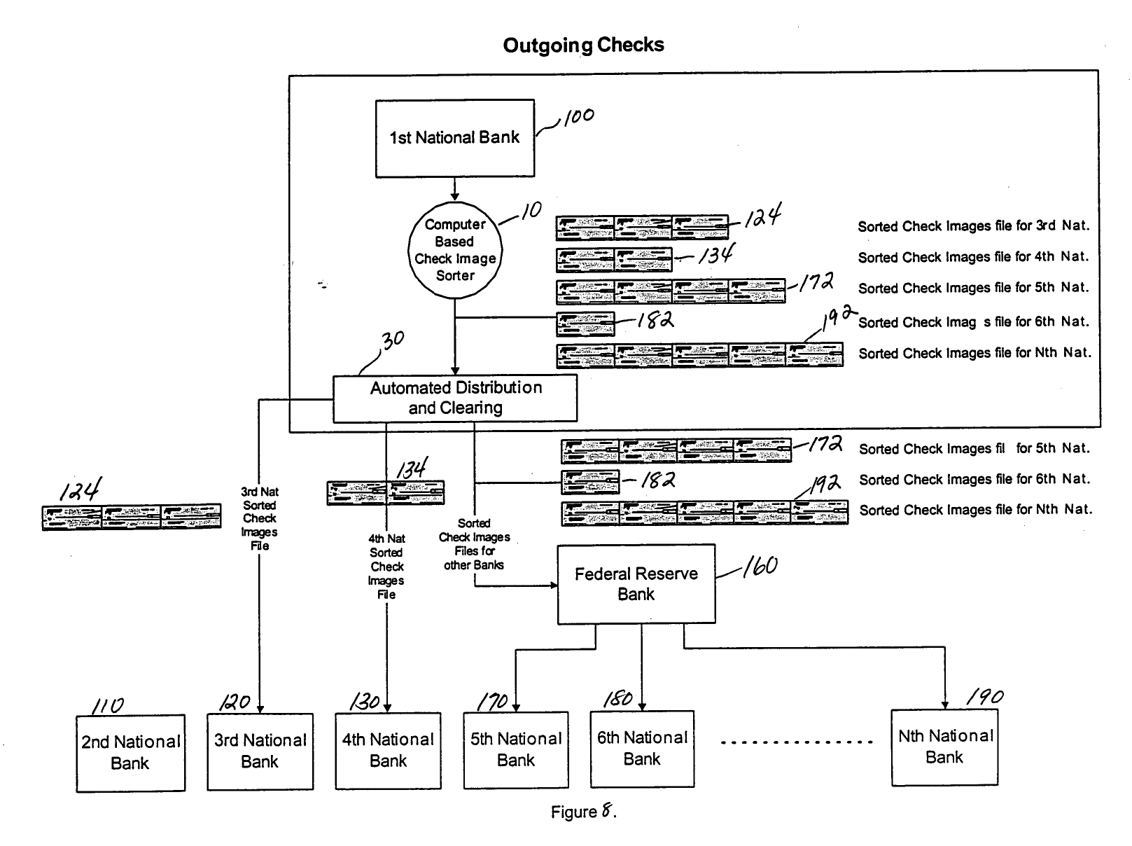

FIG. 8 provides a block diagram illustrating the processing outgoing checks from the 1^{st} National Bank 100. The 1^{st} National Bank 100 creates sorted check images 124, 134, 172, 182 and 192 from checks deposited at the 1^{st} National Bank 100, and from checks or check images received from other banks. Pursuant to agreements between the 1^{st} National Bank 100 and the 3^{rd} and 4^{th} National Banks 120 and 130, the 1^{st} National Bank 100 provides a sorted check image file 124 to the 3^{rd} National Bank 120, and a sorted check image file 134 to the 4^{th} National Bank 130. Thus, the sorted check image files 124 and 134 are directly provided to their endpoint institutions—the 3^{rd} National Bank 120 and the 4^{th} National Bank 130, respectively.

The remaining check images 172, 182, and 192, which are sorted check images for the 5^{th}, 6^{th} and N^{th} National Banks 170, 180 and 190, are provided to the Federal Reserve Bank 160, which in turn may provide the corresponding check images to the 5^{th}, 6^{th} and N^{th} National Banks as 170, 180 and 190. Thus, in this example, the sorting of the check files by the 1^{st} National Bank 100 using the check image sorter system 10 and automated distribution and clearing system 30 allows the Federal Reserve Bank 160 to deliver check files to other institutions without having the Federal Reserve Bank sort the check files. The Federal Reserve Bank 160 may charge a reduced fee for handling the presorted check files.

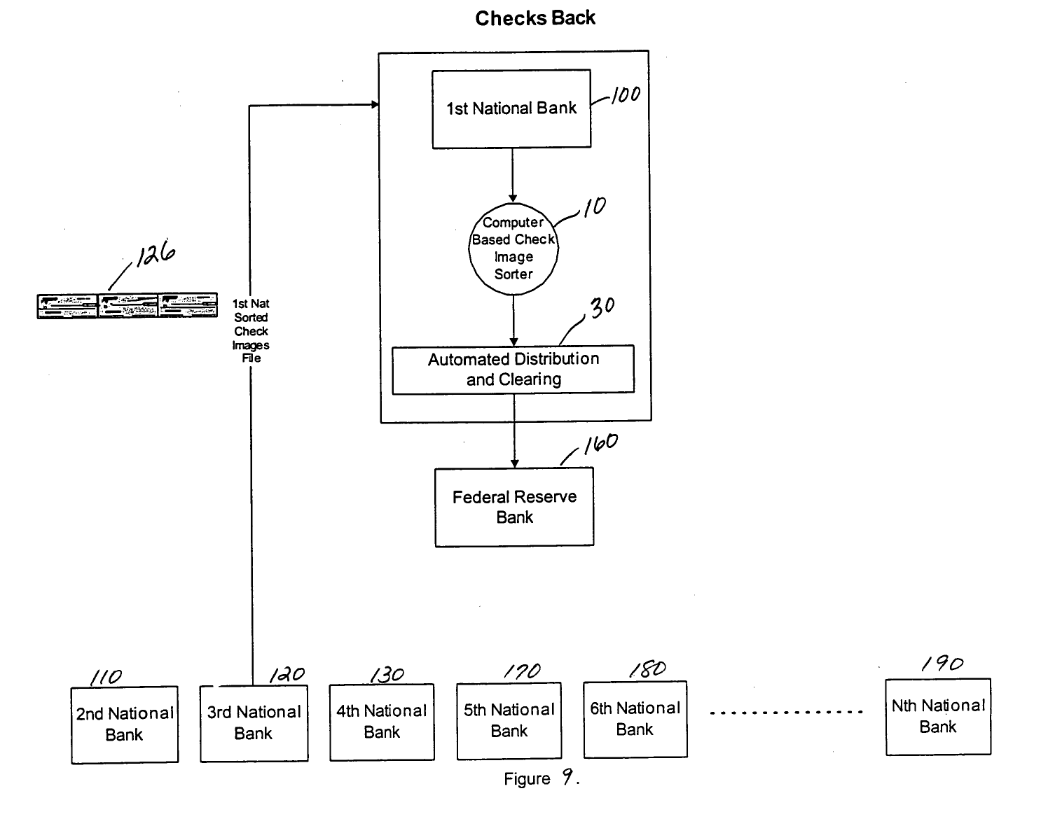

FIG. 9 provides a block diagram for received check images. Pursuant to an agreement with the 3^{rd} National Bank 120, the 1^{st} National Bank 100 receives sorted check image files 126 for 1^{st} National Bank 100 checks from the 3^{rd} National Bank 120. The 1^{st} National Bank 100 may then provide sorted check images to the Federal Reserve Bank 160.

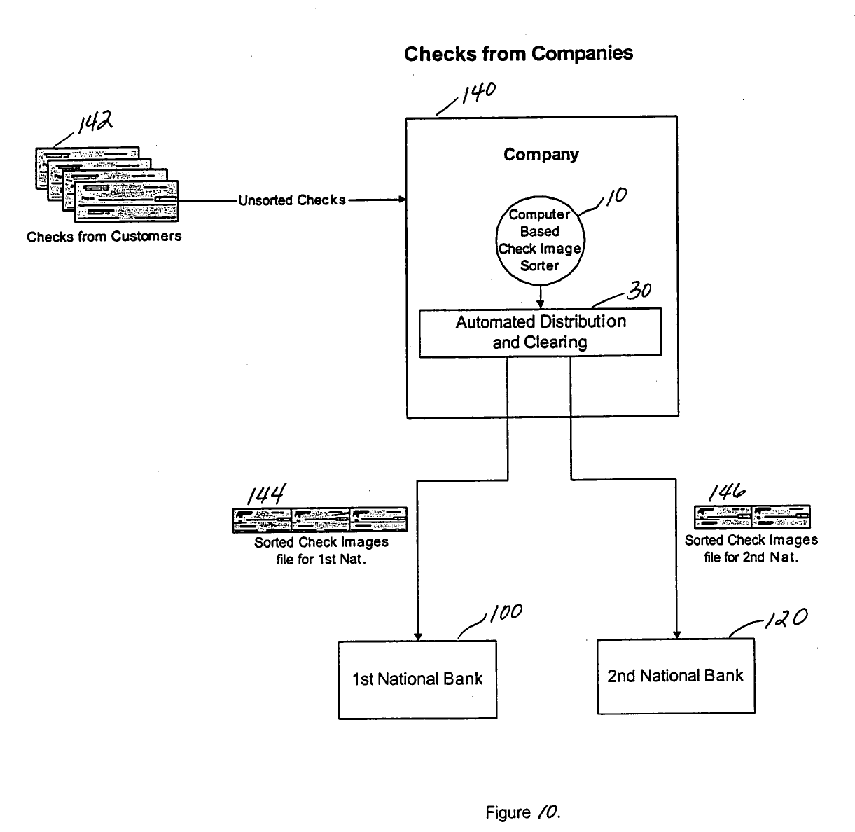

FIG. 10 illustrates a payee company 140 having a check image sorter system 10 and automated distribution and clearing system 30 to sort the checks received from its customers. The customers provide checks 142 to the payee company 140. Check images and related data files are created, and the company 140 uses the check image sorter program to sort the check files 144 and 146, based upon the endpoint banking institution. The payee company 140 may then distribute the sorted check files directly to the endpoint institutions. For example, the payee company 140 creates a set of sorted check images 144 for the 1^{st} National Bank 100, and a set of sorted check images 146 for the 2^{nd} National Bank 110. The payee company 140 may then be eligible for a reduction in fees charged by the 1^{st} and 2^{nd} National Banks 100 and 110 because the check files are presorted, or may receive a reduction in fees charged pursuant to an agreement with the 1^{st} and 2^{nd} National Banks 100 and 120.

The embodiments described herein are examples of structures, systems or methods having elements corresponding to the elements of the invention recited in the claims. This written description may enable those of ordinary skill in the art to make and use embodiments having alternative elements that likewise correspond to the elements of the invention received in the claims. The intended scope of the invention thus includes other structures, systems or methods that do not differ from the literal language of the claims, and further includes other structures, systems or methods with insubstantial differences from the literal language of the claims.

As an example of the wide scope of the approaches disclosed herein, data signals transmitted using a communication channel may be used with the check processing systems and methods. The data signals can include any type of data to be transmitted, such as a sorted check file. The data signal may be packetized data that is transmitted through a carrier wave or other medium across the network. Still further, computer-readable media may be provided to and used that is capable of causing a computer to perform the methods and implement the systems disclosed herein.

What is claimed is:

1. A computer-implemented method for the sorting of check files and facilitating the direct distribution of the check files to multiple endpoints, comprising:
receiving an unsorted check file comprising check images and related check data;
processing the unsorted check files to create sorted check images and related check data in separate sorted check files;
associating a sorted check file with a corresponding endpoint; and
directly distributing the sorted check files to their corresponding endpoints for presentment for payment from the image and related data.

2. The method of claim 1, wherein the receiving, processing, associating, and directly distributing processes are performed by a bank that captures check images of checks the bank has accepted for deposit.

3. The method of claim 1, wherein a first bank captures check images of checks the first bank has accepted for deposit, and a second bank performs the receiving, processing, associating, and directly distributing processes.

4. The method of claim 1, wherein the unsorted check file is provided by an entity that has received payment checks and has captured the check images in the check image file.

5. The method of claim 1, wherein the endpoints correspond to one or more banks.

6. The method of claim 1 further comprising:
associating a primary endpoint with a plurality of endpoints; and
directly distributing the sorted check files according to the primary endpoint.

7. The method of claim 6 further comprising:
a first sorting of the check images and related check image data according to the primary endpoints; and
a second sorting of the check images and related check image data according to the plurality of endpoints associated with the primary endpoint.

8. The method of claim 7, wherein the endpoints are ABA numbers.

9. The method of claim 1, wherein the directly distributing process comprises a timed batch transmission of sorted check files to an electronic address associated with an endpoint.

10. The method of claim 1, wherein the sorted check files conform with one or more electronic payment standards.

11. The method of claim 1 further comprising distributing one or more sorted check files to a Federal Reserve Bank.

12. The method of claim 1 further comprising storing the cumulative value of the checks transmitted in a sorted check file and the endpoint to which the sorted check file is transmitted in a reconciliation database.

13. The method of claim 12 further comprising storing the cumulative value of the checks received in the unsorted check file and an endpoint from which the unsorted check file is received in the reconciliation database.

14. The method of claim 13 further comprising generating a report that reconciles a clearing of outbound checks versus inbound checks for an endpoint.

15. A software system stored on one or more computer readable media, the software comprising instructions operable to cause one or more computers upon execution by the one or more computers to:
receive an unsorted check file comprising check images and related check data;
process the unsorted check file to create sorted check images and related check data in separate sorted check files; and
associate each sorted check file with a corresponding endpoint for direct distribution to that endpoint.

16. The software system of claim 15 further comprising instructions operable to cause one or more computers upon execution by the one or more computers to directly distribute the sorted check files to their corresponding endpoint for presentment for payment from the image and related data.

17. A system for sorting check files and facilitating the direct distribution of the check files to multiple endpoints, comprising:
means for causing one or more computers to perform the operation of receiving an unsorted check file comprising check images and related check data;
means for causing one or more computers to perform the operation of processing the unsorted check file to create sorted check images and related check data in separate sorted check files; and
means for causing one or more computers to perform the operation of associating each sorted check files with a corresponding endpoint for direct distribution to the endpoint.

18. The system of claim 17 further comprising means for causing one or more computers to perform the operation of directly distributing the sorted check files to their corresponding endpoints for presentment for payment from the image and related data.

19. A system for processing checks, comprising:
a sorting computer system comprising a processing system and a memory system, the memory system storing processing instructions operable to cause the processing system to receive an unsorted check file comprising check images and related check data, process the unsorted check file to create sorted check images and related check data in separate sorted check files, and associate each sorted check file with a corresponding endpoint for direct distribution to the endpoint; and
a sorting database operable to store endpoint data and sorting specifications and accessible by the sorting computer system.

20. The system of claim 19, wherein the sorting database comprises a data record structure stored in a computer readable medium, the data structure comprising an ABA number field, an account number field, an endpoint number field, and a primary ABA field.

21. The system of claim 20, wherein the ABA number field in a first data record structure may be associated with a primary ABA field in a second data record structure.

22. The system of claim 19 further comprising:
a direct distribution computer system comprising a processing system and a memory system, the memory system storing processing instructions operable to cause the processing system to receive the separate sorted check files and directly distribute the separate sorted check files to institutions associated with the corresponding endpoints of the separate sorted check files.

23. The system of claim 22, wherein the sorting database comprises a data record structure stored in a computer readable medium, the data structure comprising an ABA number field, an account number field, an endpoint number field, and a primary ABA field, and wherein the ABA number field in a first data record structure may be associated with a primary ABA field in a second data record structure.

24. The system of claim 23, wherein the direct distribution computer system is operable to directly distribute the separate sorted check files to institutions associated with the primary ABA field.

25. The system of claim 22, wherein the sorting computer system and the direct distribution computer system comprise a single computer system.

26. The system of claim 22, wherein the sorting computer system and the direct distribution computer system comprise a plurality of computer systems in communication over a computer network.

27. A computer-implemented method for the sorting of check files and facilitating the delivery of the check files to multiple endpoints, the method comprising the steps of:
receiving an unsorted check file of check images;
sorting the check images and creating related sort data;
storing the check images and related sort data for corresponding endpoints into endpoint check files;
directly distributing the endpoint check files to the corresponding endpoints for presentment.
